(19) United States
(12) Patent Application Publication
(10) Pub. No.: US 2005/0052513 A1
(43) Pub. Date: Mar. 10, 2005

(54) Inkjet recording head assembly and inkjet recording apparatus

(76) Inventor: Hiroshi Inoue, Ashigara-Kami-Gun (JP)

Correspondence Address: BIRCH STEWART KOLASCH & BIRCH, PO BOX 747, FALLS CHURCH, VA, 22040-0747, US

(21) Appl. No.: 10/936,669

(22) Filed: Sep. 9, 2004

(30) Foreign Application Priority Data
Sep. 10, 2003 (JP) 2003-318550

(51) Int. Cl. B41J 2/17

(52) U.S. Cl. 347/89

(57) ABSTRACT

The inkjet recording head assembly comprises: a recording head which has nozzles discharging ink; a main tank which is a supply source of the ink; and an auxiliary tank which communicates with the main tank, the auxiliary tank being in direct connection to the recording head without interposing tubes, a circulation channel being formed by the auxiliary tank and an ink flow channel in the recording head, the auxiliary tank having an exhaust channel connected to a pressure reduction device which reduces inner pressure of the auxiliary tank.

### BACKGROUND OF THE INVENTION

1. Field of the Invention

The present invention relates to an inkjet recording apparatus, and particularly relates to a structure of an ink supply system suitable for a full-line recording head having a nozzle row wherein a plurality of ink discharging nozzles are arrayed over a length corresponding to the entire width of a printing medium in the direction substantially orthogonal to the feed direction of the printing medium.

2. Description of the Related Art

An inkjet-type recording apparatus deposits ink droplets on a printing medium by moving recording paper or another such printing medium relative to a recording head with nozzles and discharging ink from the nozzles according to a print signal, and forms an image on the printing medium by means of the inkjet. In such an inkjet recording apparatus, the ink discharge from the nozzles becomes unstable when air bubbles or the like are mixed in the recording head, the amount of ink discharged (the dot size resulting from the deposited droplet on the recording paper) and the droplet deposition position (flight direction of the ink) vary, and the quality of the recorded image is reduced. Concerning these problems, a circulation system for circulating the ink in the recording head has been proposed to prevent air bubbles and the like in the recording head (see Japanese Patent Application Publication Nos. 2002-166572 and 6-24000).

The liquid circulation device disclosed in Japanese Patent Application Publication No. 2002-166572 has a structure wherein ink from an ink supply source (ink cartridge or the like) is collected in a temporary sub-tank (auxiliary tank), and the ink is fed from the sub-tank to a recording head via a supply channel. Also, the recording head is connected with the sub-tank via a supply/return channel, such that the remaining ink in the recording head is returned to the sub-tank.

Similarly, Japanese Patent Application Publication No. 6-24000 discloses a structure including two ink tanks communicated with the recording head.

However, in the structure proposed in conventional practice, the sub-tank must be installed on the lower side of the head because negative pressure corresponding to the amount of liquid pumped by the sub-tank and nozzles is applied inside the head. This is a restriction on the design of the device and allows no freedom in design.

Also, when productivity of print jobs is improved by high-speed printing, the amount of ink consumed per unit time increases, so the ink must be supplied from the sub-tank to the recording head at a proportionally higher rate. However, the tube connecting the sub-tank and the recording head is susceptible to taking in air bubbles from the outside air, so the diameter of the tube cannot be too large and is limited to a specific value or less.

Therefore, the number of tubes for supplying liquid from the sub-tank to the recording head must be increased in order to supply the recording head with an amount of ink sufficient to compensate for the amount of ink consumed. However, handling becomes complex and the device increases in size when the number of tubes is increased. Furthermore, the overall extension of the ink flow channel is lengthened, which makes it more difficult for the ink solution to circulate.

Particularly, when using a large head such as a line head (a so-called full-line recording head) having a row of nozzles extending over the entire width of the printing medium in a direction substantially orthogonal to the conveyance direction of the medium, it becomes extremely difficult to circulate the ink, and air bubbles and the like in the head cannot be efficiently discharged.

### SUMMARY OF THE INVENTION

The present invention has been implemented taking into account the above described circumstances, and an object thereof is to provide an inkjet recording head assembly and inkjet recording apparatus wherein the restrictions pertaining to the arrangement of the head and the sub-tank (auxiliary tank) are avoided to increase the level of freedom with the design, the size of the device can be reduced, and the circulation efficiency of ink within the recording head can be improved.

In order to attain the above-described object, the present invention is directed to an inkjet recording head assembly, comprising: a recording head which has nozzles discharging ink; a main tank which is a supply source of the ink; and an auxiliary tank which communicates with the main tank, the auxiliary tank being in direct connection to the recording head without interposing tubes, a circulation channel being formed by the auxiliary tank and an ink flow channel in the recording head, the auxiliary tank having an exhaust channel connected to a pressure reduction device which reduces inner pressure of the auxiliary tank.

According to the present invention, the ink fed out from the main tank, which is the ink supply source, is collected in the auxiliary tank, and is then supplied to the recording head from the auxiliary tank. The ink fed to the recording head is supplied to the nozzles through the ink flow channel and discharged from the nozzles. The ink droplets discharged from the nozzles are deposited onto recording paper or another such printing medium, and an image is formed by the dots resulting from the deposited ink.

The inkjet recording head assembly of the present invention has a structure wherein an auxiliary tank and a recording head are integrated without tubes, so the trouble with tubes that caused problems in conventional practice is eliminated and the device can be made more compact. Also, due to the tubeless structure, air bubbles from the surface of the tube do not become mixed in and permeation of external air into the flow channel is prevented.

In the present invention, the pressure in the head is maintained as negative pressure by the pressure reduction device even in a structure wherein the auxiliary tank is disposed on top of the recording head. Specifically, the pressure reduction device is connected to an exhaust channel communicated with a gas layer of the auxiliary tank, and the auxiliary tank is aspirated by the pressure reduction device, whereby the pressure in the head is adjusted to the desired state. Therefore, regarding the relative arrangement of the auxiliary tank and the recording head, which has conventionally been a restriction on design, the restrictions on the arrangement of the auxiliary tank are eliminated to allow a greater degree of freedom with the design, because it is possible to control the pressure in the auxiliary tank with the aid of the pressure reduction device in accordance with the present invention.

In the present invention, the connection between the auxiliary tank and the recording head preferably has a detachable structure whereby connection and separation is easy. Configuring the auxiliary tank to be detachable from the recording head simplifies the structure and is also advantageous in terms of maintenance operations. However, an aspect wherein the auxiliary tank and the recording head are integrally structured to be incapable of separating is also possible in the present invention.

Furthermore, in the present invention, since a circulation channel is configured between the auxiliary tank and the recording head, air bubbles mixed in the head can be efficiently discharged to the exterior of the head (the auxiliary tank) by ink circulation. Air bubbles accumulated in the auxiliary tank can also be trapped by providing a filter in the auxiliary tank, and can also be efficiently removed by reducing the pressure with the pressure reduction device. Thus, operations for suctioning and removing ink that have been conventionally performed become unnecessary, and it is possible to reduce the amount of ink consumed because air bubbles can be removed by circulating the ink and controlling the negative pressure in the head.

In one aspect of the present invention, the recording head has a plurality of independent ink flow channels formed in the recording head, and the plurality of independent ink flow channels are connected to the auxiliary tank to form a plurality of circulation channels.

In this case, it is also possible to form a plurality of circulation channels by connecting a plurality of independent ink flow channels to one auxiliary tank, and another possibility is an aspect wherein a plurality of circulation channels are formed by providing a plurality of auxiliary tanks corresponding to the plurality of independently provided ink flow channels, and connecting one auxiliary tank to each ink flow channel (an aspect wherein the auxiliary tanks and ink flow channels are connected in a ratio of 1:1).

In the case of a recording head having a nozzle row with an array of multiple nozzles, it is preferable to divide the ink supply channel into a plurality of blocks, to form independent (not mutually communicated) ink flow channels and install an auxiliary tank for each ink flow channel, and to form a plurality of circulation channels. The flow channel of each circulation channel is thereby formed in an appropriate length, and the ink is efficiently circulated.

In another aspect of the present invention, the recording head is a full-line recording head with the plurality of nozzles discharging the ink arrayed over a length corresponding to an entire width of a printing medium.

For example, in a full-line head, the ink can be efficiently circulated by segmenting the plurality of blocks along the longitudinal direction and forming independent circulation channels.

A “full-line recording head” is normally disposed along the direction orthogonal to the relative conveyance direction (direction of relative movement) of the printing medium, but also possible is an aspect in which the recording head is disposed along the diagonal direction given a predetermined angle with respect to the direction orthogonal to the direction of relative movement. The array form of the nozzles in the recording head is not limited to a single row array in the form of a line, but a matrix array composed of a plurality of rows is also possible. Furthermore, also possible is an aspect in which a plurality of short-length recording head units having a row of nozzles that do not have lengths that correspond to the entire width of the printing medium are combined, whereby the nozzle rows are configured so as all these units to correspond to the entire width of the printing medium.

The “printing medium” is a medium (media) that receives the printing of the recording head, and may be referred to as an image formation medium, recording medium, image receiving medium, or the like. The specific aspects of the printing medium include continuous paper, cut paper, seal paper, OHP sheets, and other resin sheets, as well as film, cloth, and various other media without regard to materials or shapes.

A conveyance device for moving the printing medium relative to the recording head includes an aspect in which the printing medium is conveyed with respect to a stationary (fixed) recording head, an aspect in which the recording head is moved with respect to a stationary printing medium, or an aspect in which both the recording head and the printing medium are moved.

In the present specification, the term “printing” expresses the concept of not only the formation of characters, but also the formation of images with a broad meaning that includes characters.

According to yet another aspect of the present invention, a suction port for the exhaust channel communicated with the auxiliary tank is provided to the same surface as the nozzles of the recording head.

Providing a suction port (exhaust port) communicated with the exhaust channel of the auxiliary tank to the nozzle surface of the recording head has advantages in that it allows a cap for nozzle suction and a cap for auxiliary tank suction to both be used, and makes it possible to simplify the structure of the caps.

Also, as another aspect of the present invention, the inkjet recording head assembly further comprises a pump which forces circulation of the ink in the ink flow channel, the pump being arranged in the ink flow channels. Air bubbles in the head can be accumulated in the auxiliary tank by forcefully circulating the ink by operating the pump.

In this case, the circulation channel includes a supply channel for supplying ink from the auxiliary tank to the nozzles during printing, and a liquid feed channel used during forced circulation caused by the pump.

It is also possible to supply ink to the nozzles from both the supply channel and the liquid feed channel used during forced circulation during printing, and a sufficient amount of ink to compensate for consumption can be supplied.

Another aspect of the present invention provides an inkjet recording apparatus in which the inkjet recording head assembly relating to the present invention described above is applied. Specifically, the present invention is also directed to an inkjet recording apparatus, comprising: the inkjet recording head assembly; and a pump used for the pressure reduction device, wherein the pump is also used as a nozzle suction pump which removes the ink in the nozzles by suction.

The inkjet recording apparatus has a suction device for suctioning and removing deteriorated ink in the recording head (ink infused with air bubbles, viscous ink, or the like) as necessary, and is configured such that the pump used for this nozzle suction is also used as a pressure reduction device for reducing pressure in the auxiliary tank. There is no need to install the pump for the pressure reduction device separately, and the number of pumps can be reduced in the configuration of the apparatus.

In the configuration with the combined use of the pump, a connection-switching device is provided to selectively switch the connection destination of the pressure reduction device used as the nozzle suction pump over to the nozzles or the suction port of the exhaust channel in the auxiliary tank.

Also, the inkjet recording apparatus relating to another aspect of the present invention further comprises a suction cap adapted to closely fit a nozzle surface of the recording head, the suction cap having a segmented structure divided into an exhaust side support and a nozzle side support by an inner partitioning wall, the suction cap having a configuration in which one of the exhaust side support and the nozzle side support is selectively connected to the pressure reduction device through the connection-switching device. Making the cap to perform a dual role allows the cap structure with a cap movement mechanism to be simplified.

According to the present invention, more freedom is allowed with design, and the size of the apparatus can be reduced because of a configuration in which the auxiliary tank and the recording head are integrated without tubes, a circulation channel is formed between the auxiliary tank and the head, and the pressure reduction device can be connected to the auxiliary tank. Also, the infusion of air bubbles from the liquid feed tube can be prevented, and air bubbles mixed in the head can be efficiently removed by circulating the ink and reducing the pressure in the auxiliary tank.

According to the present invention, the efficiency of circulating ink in a full-line head or other such long-length head can be improved, and it is possible to achieve objects such as shortening the time to remove air bubbles, reducing the amount of ink consumed, and improving the ink supply (refill) properties to the nozzles. Thus, it is possible to quickly improve productivity in printing.

Furthermore, according to another aspect of the present invention, the structure of the apparatus can be simplified by making the nozzle-suctioning pump or the cap to perform a dual role.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus according to an embodiment of the present invention;

FIG. 2 is a plan view of principal components of an area around a printing unit of the inkjet recording apparatus in FIG. 1;

FIG. 3A is a perspective plan view showing an example of a configuration of a print head, FIG. 3B is a partial enlarged view of FIG. 3A, and FIG. 3C is a perspective plan view showing another example of the configuration of the print head;

FIG. 4 is a cross-sectional view along a line 4-4 in FIGS. 3A and 3B;

FIG. 5 is an enlarged view showing nozzle arrangement of the print head in FIG. 3A;

FIG. 6 is a block diagram of the principal components showing the system configuration of the inkjet recording apparatus;

FIG. 7 is a flow channel structural view showing the configuration of the ink supply system in the inkjet recording apparatus of the present example;

FIG. 8 is a detailed view of a sub-tank;

FIG. 9 is a block view of the control system pertaining to the ink supply system;

FIG. 10 is a flow chart showing the sequence of the ink-filling process (the first loading);

FIG. 11 is a flow chart showing the sequence of the process for adjusting the internal pressure in the auxiliary tank;

FIG. 12 is a flow chart showing the sequence of the ink-refilling process (after the first loading);

FIG. 13 is a flow chart showing the sequence of the process for removing thickened ink in the nozzles;

FIG. 14 is a flow chart showing the sequence of the process for discharging air bubbles mixed in the head to the exterior of the head by circulating the ink; and

FIG. 15 a flow channel structural drawing showing the configuration of the ink supply system in the inkjet recording apparatus relating to another embodiment of the present invention.

### DETAILED DESCRIPTION OF THE PREFERRED EMBODIMENTS

General Configuration of an Inkjet Recording Apparatus

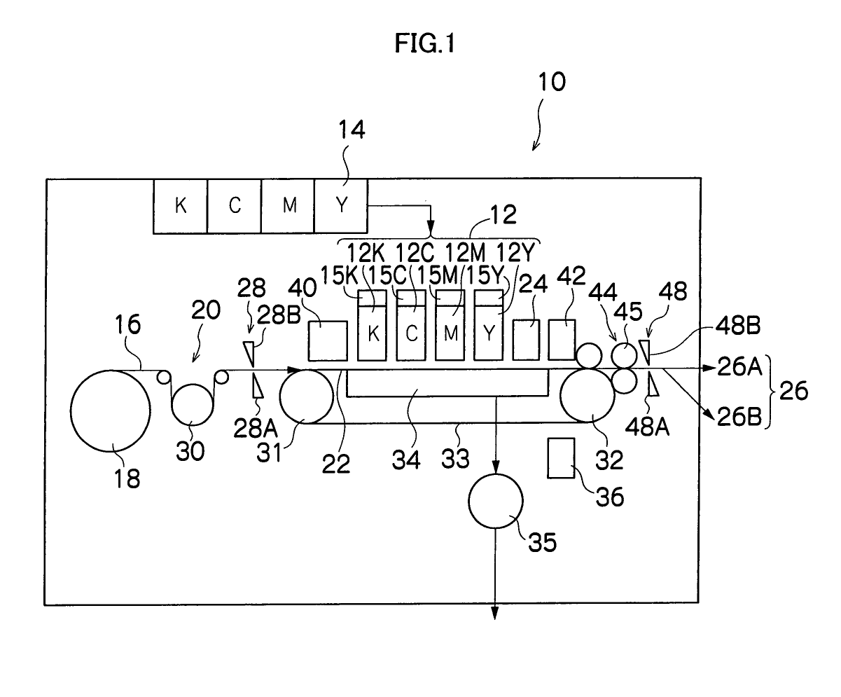

FIG. 1 is a general schematic drawing of an inkjet recording apparatus according to an embodiment of the present invention. As shown in FIG. 1, the inkjet recording apparatus 10 comprises: a printing unit 12 having a plurality of print heads 12K, 12C, 12M, and 12Y for ink colors of black (K), cyan (C), magenta (M), and yellow (Y), respectively; an ink storing/loading unit 14 for storing inks to be supplied to the print heads 12K, 12C, 12M, and 12Y; sub-tanks 15K, 15C, 15M, and 15Y integrally mounted on top of the print heads 12K, 12C, 12M, and 12Y; a paper supply unit 18 for supplying recording paper 16; a decurling unit 20 for removing curl in the recording paper 16; a line CCD sensor 21 for determining the shape, orientation, and position of the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a single magazine for rolled paper (continuous paper) is shown as an example of the paper supply unit 18; however, a plurality of magazines with paper differences such as paper width and quality may be jointly provided. Moreover, paper may be supplied with a cassette that contains cut paper loaded in layers and that is used jointly or in lieu of a magazine for rolled paper.

In the case of a configuration in which a plurality of types of recording paper can be used, it is preferable that a information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is equal to or greater than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut paper is used, the cutter 28 is not required.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1; and the suction chamber 34 provides suction with a fan 35 to generate a negative pressure, and the recording paper 16 is held on the belt 33 by suction.

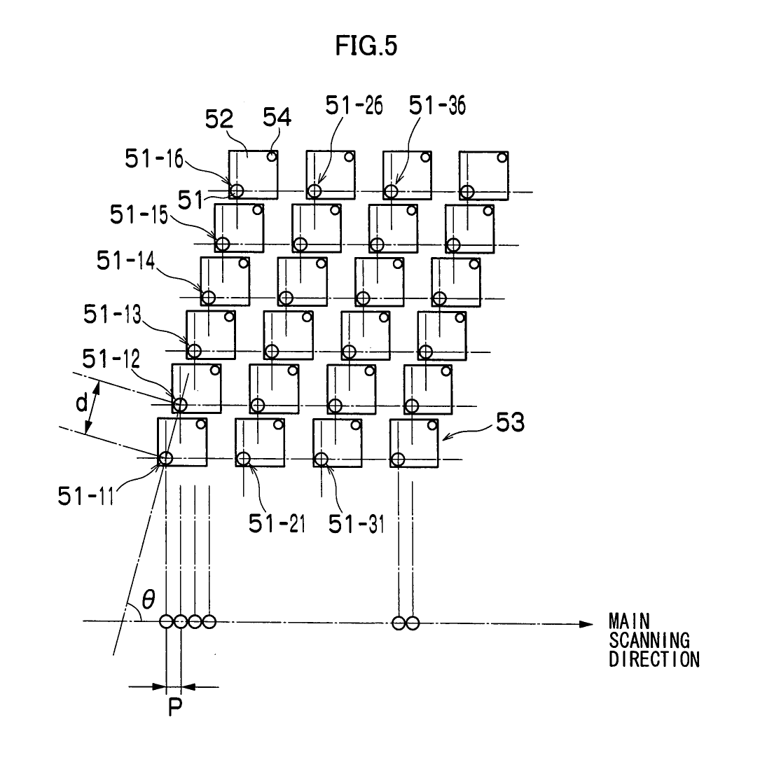

The belt 33 is driven in the clockwise direction in FIG. 1 by the motive force of a motor (not shown in FIG. 1, but shown as a motor 88 in FIG. 6) being transmitted to at least one of the rollers 31 and 32, which the belt 33 is set around, and the recording paper 16 held on the belt 33 is conveyed from left to right in FIG. 1. The belt 33 is described in detail later.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not depicted, examples thereof include a configuration in which the belt 33 is nipped with a cleaning roller such as a brush roller and a water absorbent roller, an air blow configuration in which clean air is blown onto the belt 33, or a combination of these. In the case of the configuration in which the belt 33 is nipped with the cleaning roller, it is preferable to make the line velocity of the cleaning roller different than that of the belt 33 to improve the cleaning effect.

The inkjet recording apparatus 10 can comprise a roller nip conveyance mechanism, in which the recording paper 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

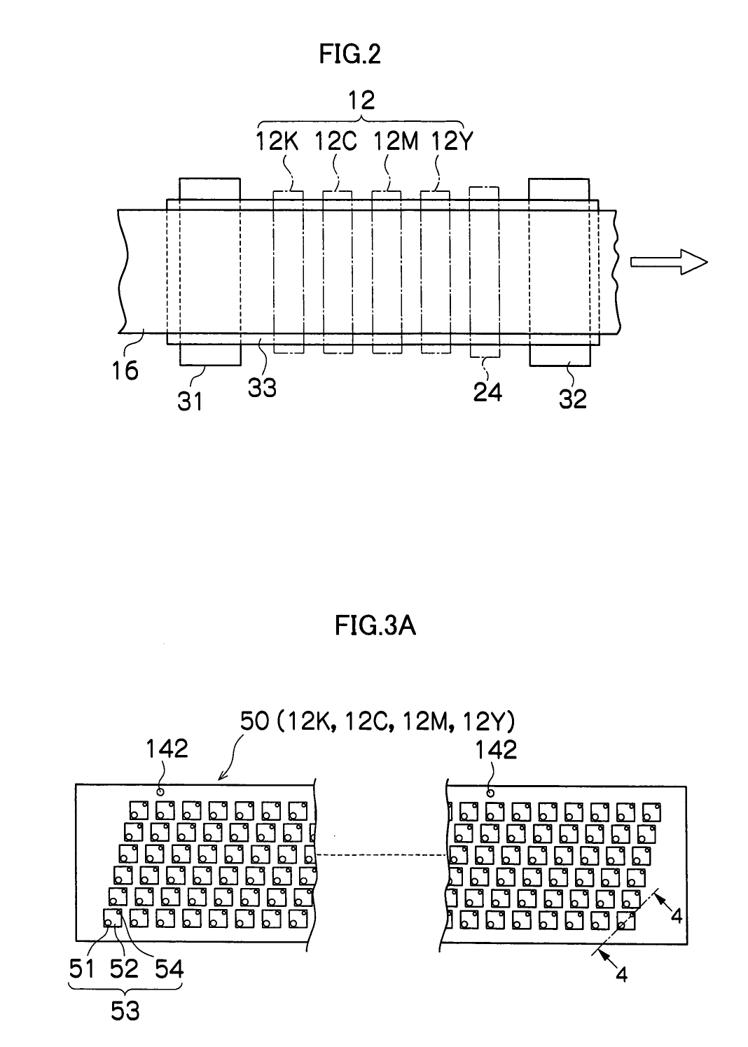

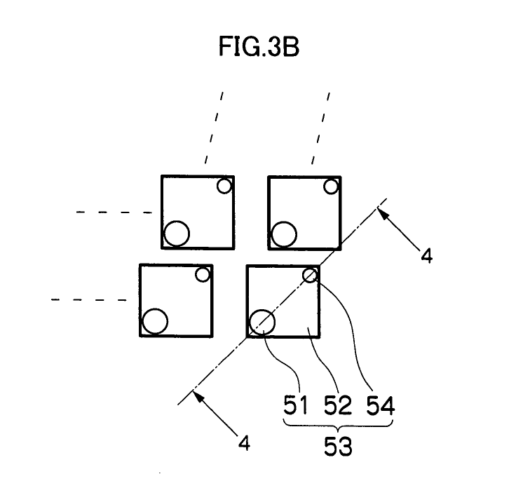

As shown in FIG. 2, the printing unit 12 forms a so-called full-line head in which a line head having a length that corresponds to the maximum paper width is disposed in the main scanning direction perpendicular to the delivering direction of the recording paper 16 (hereinafter referred to as the paper conveyance direction) represented by the arrow in FIG. 2, which is substantially perpendicular to a width direction of the recording paper 16. A specific structural example is described later with reference to FIGS. 3A to 5. Each of the print heads 12K, 12C, 12M, and 12Y is composed of a line head, in which a plurality of ink-droplet ejection apertures (nozzles) are arranged along a length that exceeds at least one side of the maximum-size recording paper 16 intended for use in the inkjet recording apparatus 10, as shown in FIG. 2.

The print heads 12K, 12C, 12M, and 12Y are arranged in this order from the upstream side along the paper conveyance direction. A color print can be formed on the recording paper 16 by ejecting the inks from the print heads 12K, 12C, 12M, and 12Y, respectively, onto the recording paper 16 while conveying the recording paper 16.

Although the configuration with the KCMY four standard colors is described in the present embodiment, combinations of the ink colors and the number of colors are not limited to those, and light and/or dark inks can be added as required. For example, a configuration is possible in which print heads for ejecting light-colored inks such as light cyan and light magenta are added. Moreover, a configuration is possible in which a single print head adapted to record an image in the colors of CMY or KCMY is used instead of the plurality of print heads for the respective colors.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the sub-scanning direction just once (i.e., with a single sub-scan). Higher-speed printing is thereby made possible and productivity can be improved in comparison with a shuttle type head configuration in which a print head reciprocates in the main scanning direction.

As shown in FIG. 1, the ink storing/loading unit 14 has tanks (main tanks) for storing the inks to be supplied to the print heads 12K, 12C, 12M, and 12Y, and the tanks are connected to the sub-tanks 15K, 15C, 15M, and 15Y of the print heads 12K, 12C, 12M, and 12Y through channels (not shown in FIG. 1), respectively. The ink storing/loading unit 14 has a warning device (e.g., a display device, an alarm sound generator) for warning when the remaining amount of any ink is low, and has a mechanism for preventing loading errors among the colors.

The print determination unit 24 has an image sensor for capturing an image of the ink-droplet deposition result of the print unit 12, and functions as a device to check for ejection defects such as clogs of the nozzles in the print unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the print heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern printed with the print heads 12K, 12C, 12M, and 12Y for the respective colors, and the ejection of each head is determined. The ejection determination includes the presence of the ejection, measurement of the dot size, and measurement of the dot deposition position. Also, the print determination unit 24 is provided with a light source (not shown) for directing light to dots formed by deposited droplets.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathway in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, a sorter for collecting prints according to print orders is provided to the paper output unit 26A for the target prints.

Next, the structure of the print heads is described. The print heads 12K, 12C, 12M, and 12Y provided for the ink colors have the same structure, and a reference numeral 50 is hereinafter designated to any of the print heads 12K, 12C, 12M, and 12Y.

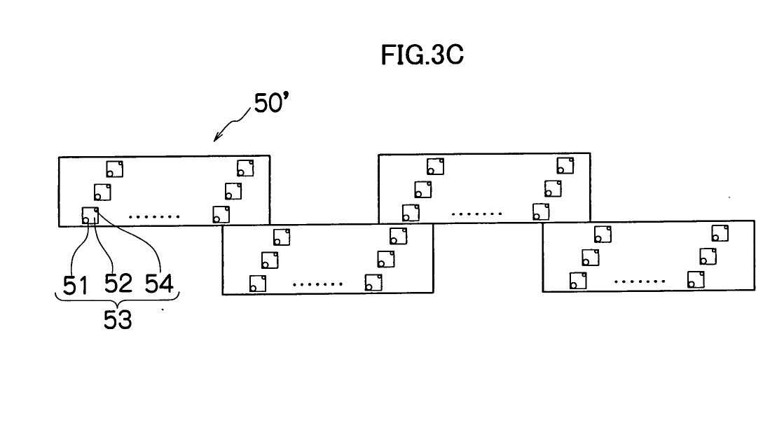

FIG. 3A is a perspective plan view showing an example of the configuration of the print head 50, FIG. 3B is an enlarged view of a portion thereof, FIG. 3C is a perspective plan view showing another example of the configuration of the print head, and FIG. 4 is a cross-sectional view taken along the line 4-4 in FIGS. 3A and 3B, showing the inner structure of an ink chamber unit.

The nozzle pitch in the print head 50 should be minimized in order to maximize the density of the dots printed on the surface of the recording paper. As shown in FIGS. 3A, 3B, 3C and 4, the print head 50 in the present embodiment has a structure in which a plurality of ink chamber units 53 including nozzles 51 for ejecting ink-droplets and pressure chambers 52 connecting to the nozzles 51 are disposed in the form of a staggered matrix, and the effective nozzle pitch is thereby made small.

Thus, as shown in FIGS. 3A and 3B, the print head 50 in the present embodiment is a full-line head in which one or more of nozzle rows in which the ink discharging nozzles 51 are arranged along a length corresponding to the entire width of the recording medium in the direction substantially perpendicular to the conveyance direction of the recording medium.

Alternatively, as shown in FIG. 3C, a full-line head can be composed of a plurality of short two-dimensionally arrayed head units 50′ arranged in the form of a staggered matrix and combined so as to form nozzle rows having lengths that correspond to the entire width of the recording paper 16.

The planar shape of the pressure chamber 52 provided for each nozzle 51 is substantially a square, and the nozzle 51 and an inlet of supplied ink (supply port) 54 are disposed in both corners on a diagonal line of the square. As shown in FIG. 4, each pressure chamber 52 is connected to a common channel 55 through the supply port 54. The common channel 55 is connected to an ink supply tank, which is a base tank that supplies ink, and the ink supplied from the ink tank is delivered through the common flow channel 55 to the pressure chamber 52.

An actuator 58 having a discrete electrode 57 is joined to a pressure plate 56, which forms the ceiling of the pressure chamber 52, and the actuator 58 is deformed by applying drive voltage to the discrete electrode 57 to eject ink from the nozzle 51. When ink is ejected, new ink is delivered from the common flow channel 55 through the supply port 54 to the pressure chamber 52.

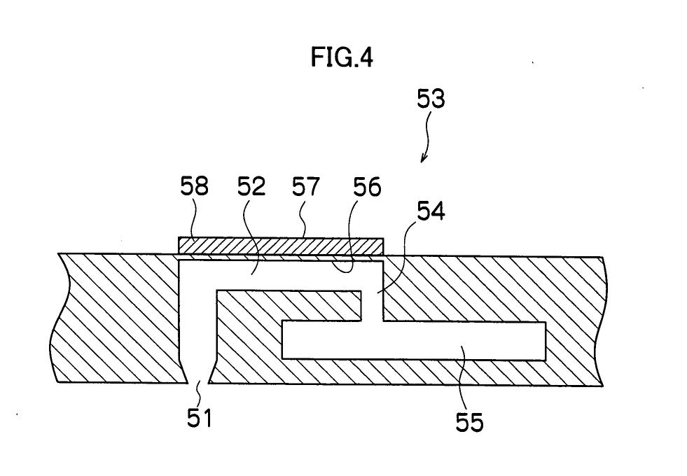

The plurality of ink chamber units 53 having such a structure are arranged in a grid with a fixed pattern in the line-printing direction along the main scanning direction and in the diagonal-row direction forming a fixed angle θ that is not a right angle with the main scanning direction, as shown in FIG. 5. With the structure in which the plurality of rows of ink chamber units 53 are arranged at a fixed pitch d in the direction at the angle θ with respect to the main scanning direction, the nozzle pitch P as projected in the main scanning direction is d× cos θ.

Hence, the nozzles 51 can be regarded to be equivalent to those arranged at a fixed pitch P on a straight line along the main scanning direction. Such configuration results in a nozzle structure in which the nozzle row projected in the main scanning direction has a high density of up to 2,400 nozzles per inch. For convenience in description, the structure is described below as one in which the nozzles 51 are arranged at regular intervals (pitch P) in a straight line along the lengthwise direction of the head 50, which is parallel with the main scanning direction.

In a full-line head comprising rows of nozzles that have a length corresponding to the maximum recordable width, the “main scanning” is defined as to print one line (a line formed of a row of dots, or a line formed of a plurality of rows of dots) in the width direction of the recording paper (the direction perpendicular to the delivering direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block, . . . ); and one line is printed in the width direction of the recording paper 16 by sequentially driving the nozzles 51-11, 51-12, . . . , 51-16 in accordance with the conveyance velocity of the recording paper 16.

On the other hand, the “sub-scanning” is defined as to repeatedly perform printing of one line (a line formed of a row of dots, or a line formed of a plurality of rows of dots) formed by the main scanning, while moving the full-line head and the recording paper relatively to each other.

In the implementation of the present invention, the structure of the nozzle arrangement is not particularly limited to the examples shown in the drawings. Moreover, the present embodiment adopts the structure that ejects ink-droplets by deforming the actuator 58 such as a piezoelectric element; however, the implementation of the present invention is not particularly limited to this. Instead of the piezoelectric inkjet method, various methods may be adopted including a thermal inkjet method in which ink is heated by a heater or another heat source to generate bubbles, and ink-droplets are ejected by the pressure thereof.

FIG. 6 is a block diagram of the principal components showing the system configuration of the inkjet recording apparatus 10. The inkjet recording apparatus 10 has a communication interface 70, a system controller 72, an image memory 74, a motor driver 76, a heater driver 78, a print controller 80, an image buffer memory 82, a head driver 84, and other components.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to memory composed of a semiconductor element, and a hard disk drive or another magnetic medium may be used.

The system controller 72 controls the communication interface 70, image memory 74, motor driver 76, heater driver 78, and other components. The system controller 72 has a central processing unit (CPU), peripheral circuits therefor, and the like. The system controller 72 controls communication between itself and the host computer 86, controls reading and writing from and to the image memory 74, and performs other functions, and also generates control signals for controlling a heater 89 and the motor 88 in the conveyance system.

The motor driver (drive circuit) 76 drives the motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to apply the generated print control signals (print data) to the head driver 84. Required signal processing is performed in the print controller 80, and the ejection timing and ejection amount of the ink-droplets from the print head 50 are controlled by the head driver 84 on the basis of the image data. Desired dot sizes and dot placement can be brought about thereby.

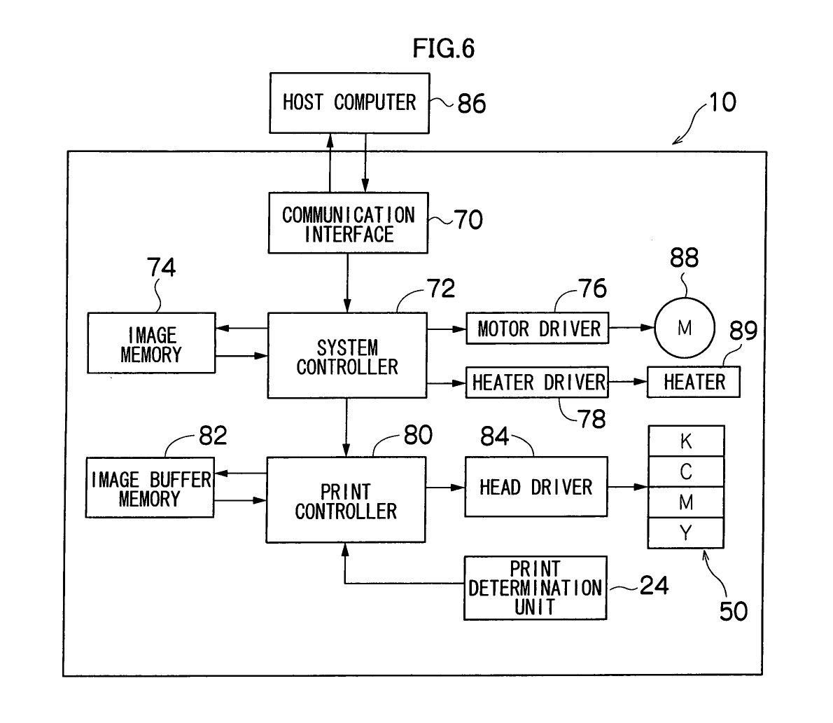

The print controller 80 is provided with the image buffer memory 82; and image data, parameters, and other data are temporarily stored in the image buffer memory 82 when image data is processed in the print controller 80. The aspect shown in FIG. 7 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head driver 84 drives actuators for the print heads 12K, 12C, 12M, and 12Y of the respective colors on the basis of the print data received from the print controller 80. A feedback control system for keeping the drive conditions for the print heads constant may be included in the head driver 84.

Description of Ink Supply System

The structure of the ink supply system will now be described. FIG. 7 is a structural drawing of a flow channel showing the configuration of the ink supply system in the inkjet recording apparatus.

In FIG. 7, the symbol 100 is an ink bottle, 102 is a filter, 104 is a core liquid feed channel, 110 is a sub-tank, 50 is a full-line print head, and 112 is a suction cap.

The ink bottle 100 is a primary tank (main tank) for supplying ink to the print head 50, and this bottle is mounted on the ink storing/loading unit 14 described in FIG. 1. Examples of an embodiment of the ink bottle 100 include a system of refilling ink from a refill opening (not shown), and a cartridge system of replacing the tanks when the remaining amount of ink runs low. The cartridge system is used when the type of ink varies according to the intended use. In this case, it is preferable to identify the information of the type of ink with a barcode or the like, and to control ink discharge according to the type of ink.

The top of the print head 50 is provided with a plurality (three in FIG. 7) of sub-tanks 110 in the longitudinal direction thereof, as shown in FIG. 7. The sub-tanks (auxiliary tanks) 110 are linked to the print head 50 by a tubeless connection.

Specifically, ink circulation ports 114 and 115 are formed on the bottom surface of the sub-tanks 110, and link ports 116 and 117 capable of directly fitting over the circulation ports 114 and 115 are provided on the side of the print head 50. Also, since negative pressure must be maintained in the head, the sub-tanks 110 are provided with exhaust channels 121 for aspirating the gas layers (damper layers) 120, and exhaust ports 122 are formed on the bottom surface of the tanks. Link ports 124 capable of directly fitting over the exhaust ports 122 of the sub-tanks 110 are provided on the side of the print head 50.

In the present example, detachable couplers are used for the circulation ports 114 and 115, the exhaust ports 122, and in their corresponding link ports 116, 117, and 124. The couplers have valve structures (not shown) that are communicated with each other only during connection, and that are closed when the connection is not in effect. For example, the circulation ports 114 and 115 and exhaust ports 122 are provided with check valves (not shown) firmly affixed in the direction in which the flow channels close, and the link ports 116, 117, and 124 are provided with protuberances (not shown) for pushing up the valves during connection.

The gas layers 120 of the sub-tanks 110 are communicated with the core liquid feed channel 104 via valves 126, and ink is supplied to the sub-tanks 110 from the ink bottle 100 via the core liquid feed channel 104. A filter 102 for removing impurities and air bubbles is provided between the ink bottle 100 and the sub-tanks 110. The filter/mesh size is preferably equal to or less than the nozzle diameter (generally about 20 μm).

A number of independent ink flow channels 130 corresponding to the number of sub-tanks 110 installed is formed inside the print head 50. In the present example, the interior of the print head 50 is divided into three blocks along the longitudinal direction of the print head 50 (horizontal direction in FIG. 7), and independent ink flow channels 130 are formed in each block. FIG. 7 shows the internal structure of only the block farthest to the left, but the other blocks are identical. It is apparent that the number of independent ink flow channels 130 is not limited to the example in the present embodiment, and the design can be such that an appropriate number of one or more (preferably a plurality) is used according to the size of the head.

As shown in FIG. 7, a common flow channel 55 communicated with the sub-tanks 110, and a plurality of pressure chambers 52 diverging from the common flow channel 55 are formed in each block of the print head 50, and a nozzle 51 is formed in each pressure chamber 52. Also, a pump 132 is provided to the liquid feed channel communicated with the common flow channel 55, as shown in FIG. 7. This pump 132 has a structure including a check valve for both the suction port and the discharge port, wherein pressure is applied in only the direction shown by the arrow A in FIG. 7 by moving a movable body back and forth.

The ink in the head can be forced to circulate by driving the pump 132. The circulation channel includes a liquid feed channel for forced circulation by means of the pump 132, and a return route for returning the ink from the pressure chambers 52 to the sub-tanks 110. The return route functions as an ink supply channel for supplying ink from the sub-tanks 110 to the nozzles 51 during refills.

Also, exhaust channels 136 communicated with the exhaust ports 122 of the sub-tanks 110 are formed in the blocks of the print head 50. Valves 138 are provided to the exhaust channels 136, and exhaust ports (suction ports) 142 are formed in the bottom surface of the print head 50, or, specifically, in the nozzle surface 140. The exhaust ports 142 are provided at specific locations so as to not hinder the matrix array of the nozzles 51 (see FIG. 3).

In the blocks of the print head 50 with the configuration described above, a plurality of independent circulation channels are formed in each block by linking the sub-tanks 110 as shown in FIG. 7.

The suction cap 112 is large enough to cover the area of one block in the print head 50, and the inner side is divided into an exhaust side support (left side of the partitioning wall 146 in FIG. 7) and a nozzle side support (right side of the partitioning wall 146 in FIG. 7) by the partitioning wall 146. The suction cap 112 is capable of moving to the left and right of FIG. 7 due to a movement mechanism (not shown), and is capable of ascending and descending towards the top and bottom due to a lifting mechanism (not shown). The suction cap 112 can be moved to the desired location in the print head 50 and can be made to closely fit the nozzle surface 140 by driving and controlling the movement mechanism and the lifting mechanism as necessary.

When the ink in the head is forced to circulate by the pump 132, it is preferable for the suction cap 112 to closely fit the nozzle surface 140 and for leakage of ink from the nozzles 51 to be prevented.

A pump 152 is connected to the suction cap 112 via a selector 150. The selector 150 is a switching valve for switching the connection destination of the suction port in the pump 152, and the connection destination of the pump 152 is switched to the exhaust side or the nozzle side according to a control signal. The discharge port in the pump 152 is communicated with an ink recovery tank 154.

According to such a configuration, it is possible to switch between suctioning the nozzles 51 and suctioning the sub-tanks 110 by means of a single suction cap 112 and pump 152.

When no ink is discharged from the nozzles 51 of the print head 50 over a certain amount of time, the ink solvent near the nozzles evaporates, the viscosity of the ink near the nozzles increases, and ink cannot be discharged from the nozzles 51 even when the actuator 58 operates. Therefore, before such circumstances occur (while the viscosity allows the possibility of discharge by the actuator 58), the actuator 58 is operated to receive the ink, and “preparatory discharge” is performed, in which the ink near the nozzles with increased viscosity is discharged. Also, after stains on the nozzle surface are washed off by a cleaning blade or another such wiper (not shown) provided as a washing device for the nozzle surface, a preparatory discharge is performed to prevent impurities from getting mixed in the nozzle due to the rubbing operation of the wiper. The preparatory discharge is also sometimes referred to as “empty discharge,” “purging,” “liquid discharge,” or the like.

When the increasing viscosity of the ink in the nozzles 51 exceeds a certain level, the suction operation described below is performed because the ink cannot be discharged by the above-mentioned preparatory discharge.

Specifically, when air bubbles become mixed in the nozzles 51 and in the ink in the pressure chambers 52, the ink cannot be discharged form the nozzles 51 even when the actuator 58 operates. The ink cannot be discharged form the nozzles 51 even when the actuator 58 operates also when the viscosity of the ink in the nozzles 51 exceeds a certain level. In such a case, a suction device for drawing out the ink in the pressure chambers 52 with a pump or the like is provided to the nozzle surface 140, and bubbled or thickened ink is suctioned out.

However, the suction operation described above consumes a large amount of ink because it is performed for all the ink in the pressure chambers. Therefore, it is preferable to perform the preparatory discharge, if possible, when the increase in viscosity is low.

The suction cap 112 described in FIG. 7 functions as a suction device, and is also capable of functioning as an ink receptacle in the preparatory discharge.

Also, though not shown in FIG. 7, the inkjet recording apparatus of the present example is provided with a preservation cap for covering the entire nozzle surface 140 of the print head 50 separately from the suction cap 112. The preservation cap is a device for preventing the nozzles 51 from drying or for preventing an increase in the viscosity of the ink near the nozzles, and the device can be made to closely fit the nozzle surface 140 of the print head 50 by means of the movement mechanism and the lifting mechanism (not shown). All of the nozzles 51 and the exhaust ports 142 are covered by the preservation cap to prevent evaporation when the power source is off or during printing standby.

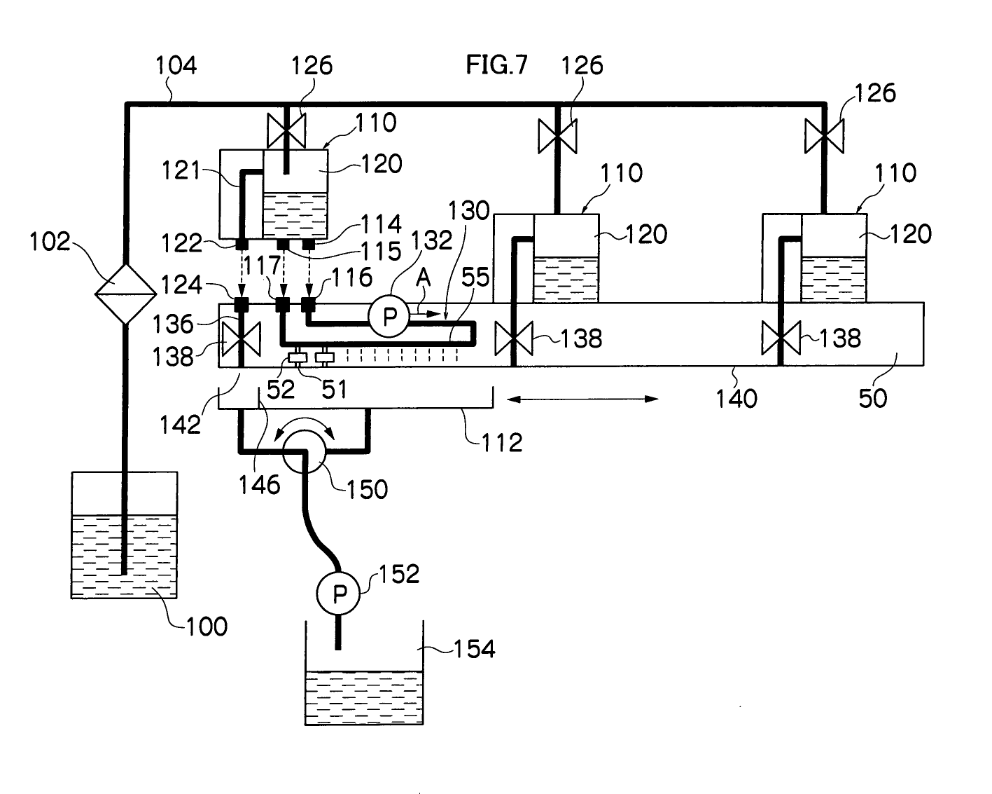

FIG. 8 is a detailed view of the sub-tank 110.

As shown in FIG. 8, a liquid surface detecting sensor 160 and a pressure sensor 162 are installed in the sub-tank 110. The amount of ink in the sub-tank 110 is determined by the liquid surface detecting sensor 160, and information concerning the pressure in the sub-tank 110 is obtained by the pressure sensor 162. The supply of ink is controlled, the presence or absence of air bubbles is determined, and negative pressure is controlled based on the information from these sensors. Also, the exhaust ports 122 of the sub-tanks 110 are communicated with the gas layers 120 of the sub-tanks 110 via the exhaust channels 121, and are connected with the exhaust channels 136 next to the print head 50, as described in FIG. 7.

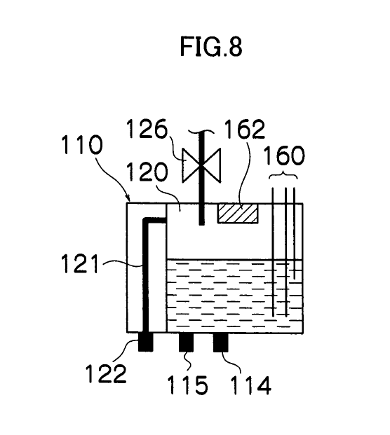

FIG. 9 is a block view of the control system pertaining to the ink supply system. The system controller 72 reads a determination signal from the liquid surface detecting sensor 160 and the pressure sensor 162 according to a specific program, and controls the operation of the valves 126 and 138, the selector 150, the pumps 152 and 132, the suction cap drive unit 170, the preservation cap drive unit 172, and the like on the basis of this information. Also, the system controller 72 controls the setting and resetting of a timer 174, and implements specific operations according to the information from the timer 174.

The operation of the inkjet recording apparatus 10 configured as described above will be described.

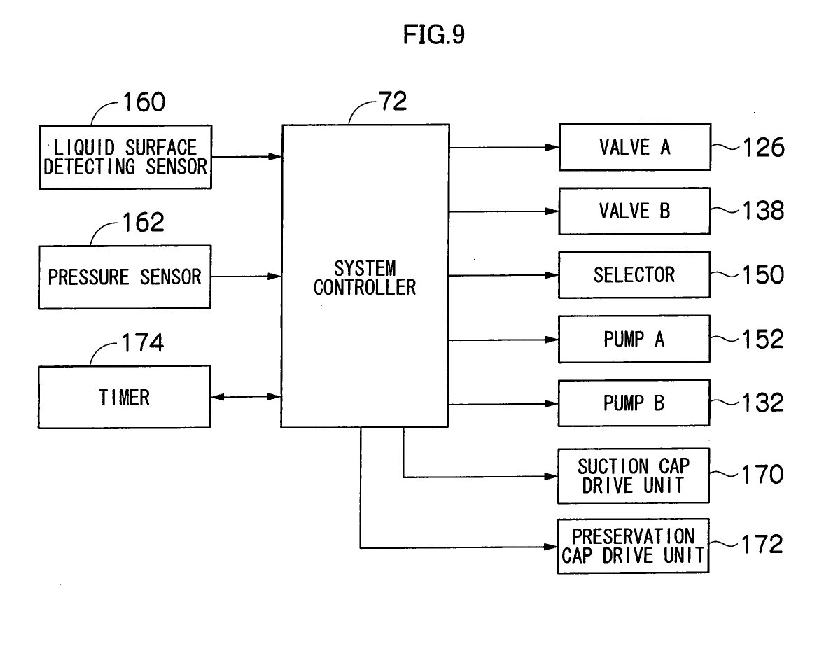

FIG. 10 is a flow chart showing the sequence of the ink-filling process (the first loading).

When the ink-filling process starts, the valves 126 leading to the core liquid feed channel 104 and the valves 138 leading to the exhaust ports 142 are first opened (step S210), and the selector 150 switches to the sub-tanks 110 side (in other words, the exhaust side) (step S212). Next, an air hole (not shown) leading to the suction cap is opened, and the suction cap 112 comes into contact and caps the nozzle surface 140 (exhaust ports 142) (step S214). After capping, the air hole is closed and sealed, and the pump 152 is actuated (step S216). Ink is supplied from the ink bottle 100 to the sub-tanks 110 by the operation of the pump 152. The system controller 72 monitors determination signals from the liquid surface detecting sensor 160, and determines whether the amount of ink in the sub-tank 110 has reached a specific reference amount (step S218).

When the amount of ink does not reach the reference amount (determination is NO), it is determined from a pump drive initiation command whether a specific amount of time has passed (step S220). When the determination is NO in step S220, the pump 152 continues to be driven and the process returns to step S218. Also, when the determination is YES in step S220 (specifically, when the amount of ink has not reached the stipulated value after a specific amount of time has passed), an alarm step is performed (step S222). Various embodiments of the alarm step are possible, including the output of a warning sound, a warning lamp display, an error message display, delivery of a communication signal, a suitable combination of these, and the like.

On the other hand, when it is determined that the amount of ink has reached the specific reference amount in step S218 (determination is YES), the pump 152 is stopped (step S224).

Next, the valves 138 for exhaust are closed (step S226), the selector 150 is switched to the nozzle side (step S228), and then the pump 152 is actuated (step S230). The continuous driving of the pump 152 at this time is managed by the timer 174, and the pump 152 stops after a pre-programmed specific amount of time.

A determination signal from the pressure sensor 162 is then read, and it is determined whether the pressure in the sub-tanks 110 is within a specific stipulated value (step S232). When it is determined that he pressure in the sub-tanks 110 is within a specific stipulated value, it is assumed that the tank is filled with ink in a regular manner and a standby mode is established (step S234). The process described above is performed for each block of the print head 50 (each independent circulation channel) while the position of the suction cap 112 is changed.

Also, in step S232, when the pressure in the sub-tanks 110 exhibits a different value when compared to the specific stipulated value (determination is NO), the process then continues to an internal pressure adjustment routine (step S236).

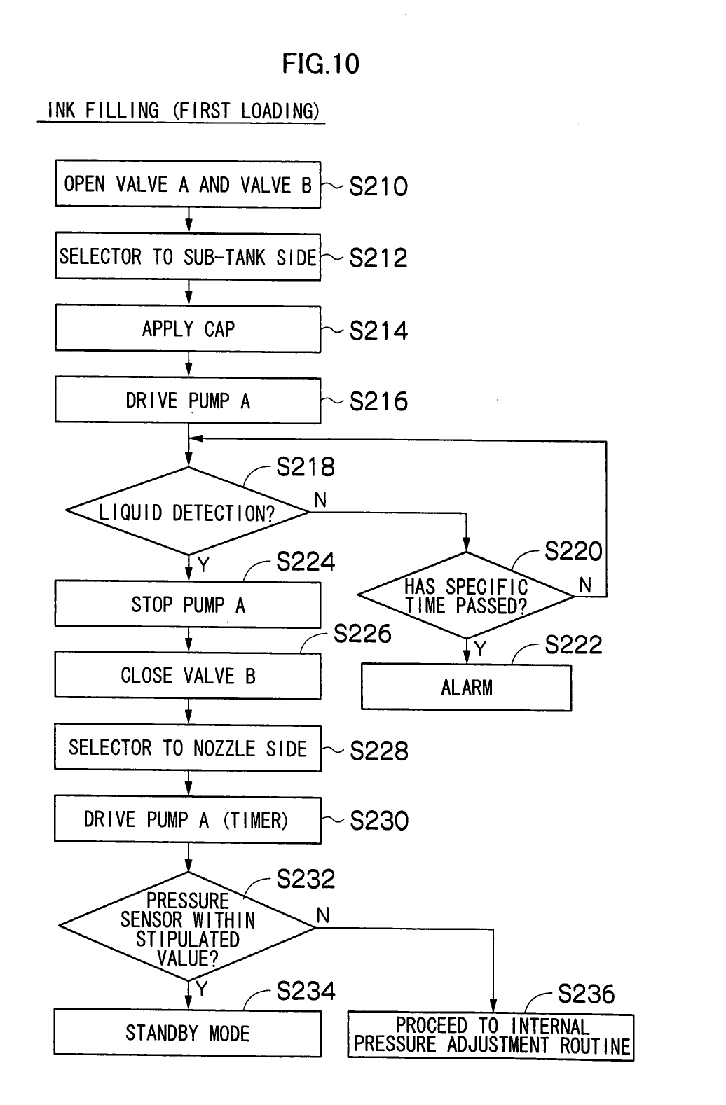

FIG. 11 is a flow chart showing the sequence of a process for adjusting internal pressure. The internal pressure adjustment routine shown herein is performed as necessary not only during pressure errors in the first loading process described in FIG. 10, but also when a decrease in pressure is detected during printing. Specifically, ink consumed by the print head 50 during printing operations is supplied due to the capillary phenomenon, but sometimes the ink cannot be sufficiently refilled during continuous printing or the like, and the pressure in the sub-tanks 110 decreases. The routine for adjusting internal pressure shown in FIG. 11 is performed in this case as well.

Specifically, when the pressure sensor 162 detects a pressure decrease in the sub-tanks 110 (step S310), the selector 150 switches over to the exhaust side (step S312), and the suction cap 112 is applied to the nozzle surface 140 (step S314). At this point, the air hole (not shown) in the suction cap 112 is opened, capping is performed, and the air hole is closed and sealed after capping. The pump 152 is then driven (step S316).

The system controller 72 picks up a determination signal from the pressure sensor 162 and determines whether the pressure in the sub-tanks 110 is within a specific stipulated value (step S318).

If the pressure determined by the pressure sensor 162 is not within the specific stipulated value (determination is NO), then it is determined whether a specific amount of time has passed since the instruction for pump drive initiation (step S320). In step S320, when the determination is NO, the pump 152 continues to be driven and the process returns to step S318. Also, when the determination is YES in step S320 (specifically, when the specific amount of time has passed and the amount of ink has not reached the stipulated value), the alarm step is performed (step S322).

On the other hand, if it is determined that the pressure is within the specific stipulated value in step S318 (determination is YES), then the pump 152 is stopped (step S324). The air hole in the suction cap 112 is then opened to bring the negative pressure in the cap to atmospheric pressure, and the suction cap 112 is then removed from the nozzle surface 140 and moved to a specific retracted location (step S326).

The internal pressure adjustment routine described above is performed as necessary for each circulation channel according to the frequency of nozzle usage and the like.

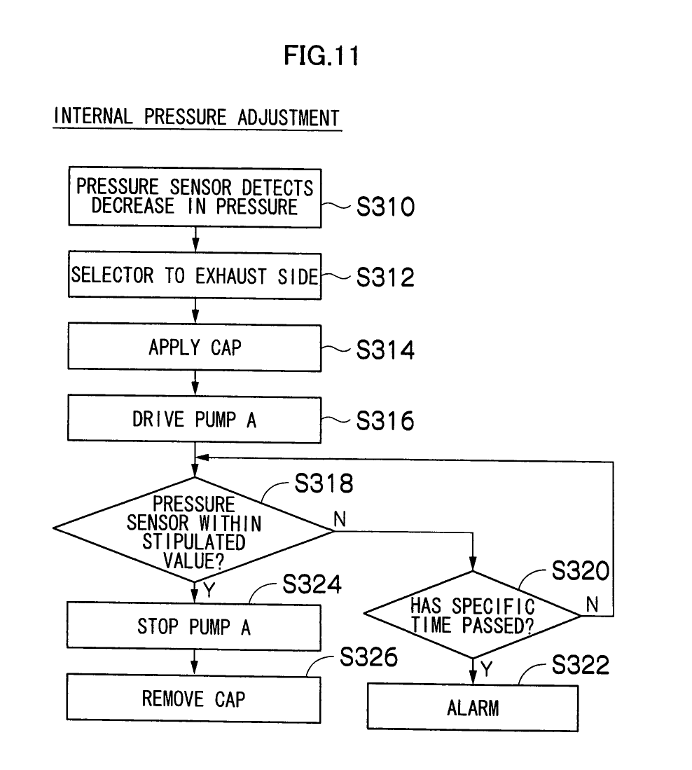

FIG. 12 is a flow chart showing the sequence of the ink-refilling process performed as necessary after the first loading. As already described, the ink consumed by the print head 50 is supplied by the capillary phenomenon, but the amount of ink in the sub-tanks 110 may sometimes decrease due to the effects of air bubbles and the like. When a decrease in the liquid surface is detected by the liquid surface detecting sensor 160, the ink refilling process shown in FIG. 12 is performed.

Specifically, when the liquid surface detecting sensor 160 detects a decrease in the liquid surface (step S410), the suction cap 112 is moved to the corresponding position and the nozzle surface 140 is capped (step S412). At this point, the air hole (not shown) in the suction cap 112 is opened to perform capping, and after capping the air hole is closed and sealed. The selector 150 then switches to the exhaust side (step S414), the exhaust valves 138 are opened (step S416), and the pump 152 is actuated (step S418).

The system controller 72 picks up a determination signal from the liquid surface detecting sensor 160 and determines whether the amount of ink in the sub-tanks 110 is within a specific standard value (step S420).

When the amount of ink does not reach the specific reference amount (determination is NO), it is determined whether a specific amount of time has passed since the instruction for pump drive initiation (step S422). When the determination is NO in step S422, the pump 152 continues to be driven and the process returns to step S420. Also, when the determination is YES in step S422 (specifically, when the specific amount of time has passed), the alarm is activated (step S424).

On the other hand, if the amount of ink is detected to have reached the specific reference amount in step S420 (determination is YES), the pump 152 is stopped (step S426). The air hole in the suction cap 112 is then opened to bring the negative pressure in the cap to atmospheric pressure, and then the suction cap 112 is removed from the nozzle surface 140 and moved to a specific retracted location (step S428).

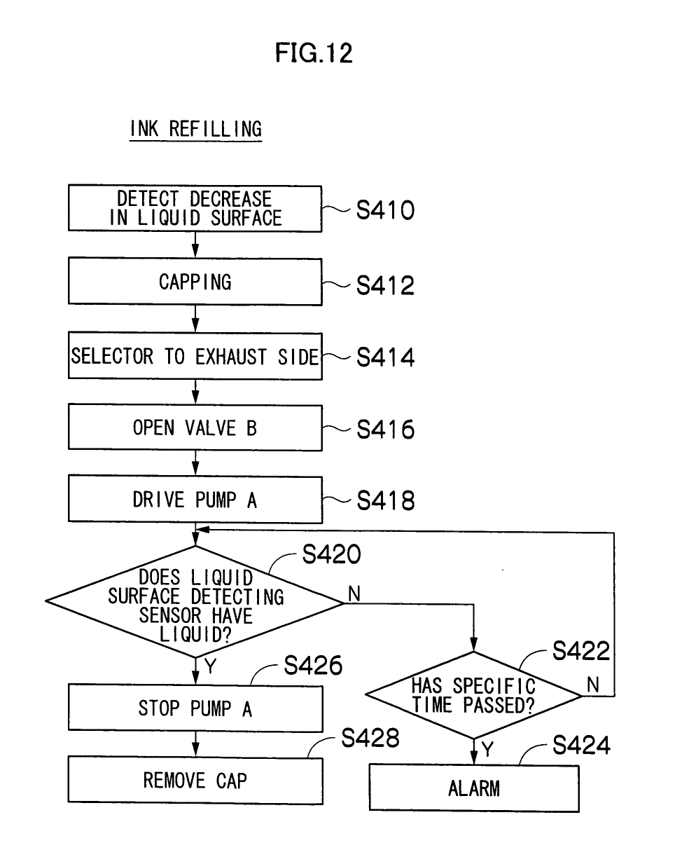

FIG. 13 is a flow chart showing the sequence of the process for removing thickened ink in the nozzles. When ink is not discharged over a long period of time, the viscosity of the ink in the print head 50 increases due to evaporation of the ink solvent and the like. The resulting thickened ink is the cause of discharge failures, so a process for removing the thickened ink from within the print head 50 is performed under specific conditions, such as managing the time of nonuse with the timer 174.

When air bubbles become mixed in the ink and the piezoelement is deformed, the displacement thereof is absorbed by the air bubbles and the ink can no longer be discharged; therefore, the ink with the air bubbles is removed by the ink suction operation described as follows.

Specifically, when the process of removing the thickened ink (or the ink with air bubbles) starts, first, the selector 150 switches to the nozzle side (step S510) and the valves 126 leading to the core liquid feed channel 104 are opened (step S512). Next, the air hole (not shown) leading through the suction cap 112 is opened to bring the suction cap 112 in contact with the print head 50, capping is performed, and the air hole is then closed and sealed (step S514). The pump 152 is then driven (step S516). The ink in the head is suctioned and removed by the operation of the pump 152, and new ink is supplied to the print head 50 from the sub-tanks 110. The time during which the pump 152 is continuously driven is managed by the timer 174, and the pump 152 automatically stops after a pre-programmed specific amount of time.

The air hole in the suction cap 112 is then opened to bring the negative pressure in the cap to atmospheric pressure, and then the suction cap 112 is removed from the nozzle surface 140 (step S518) and moved to a specific retracted location.

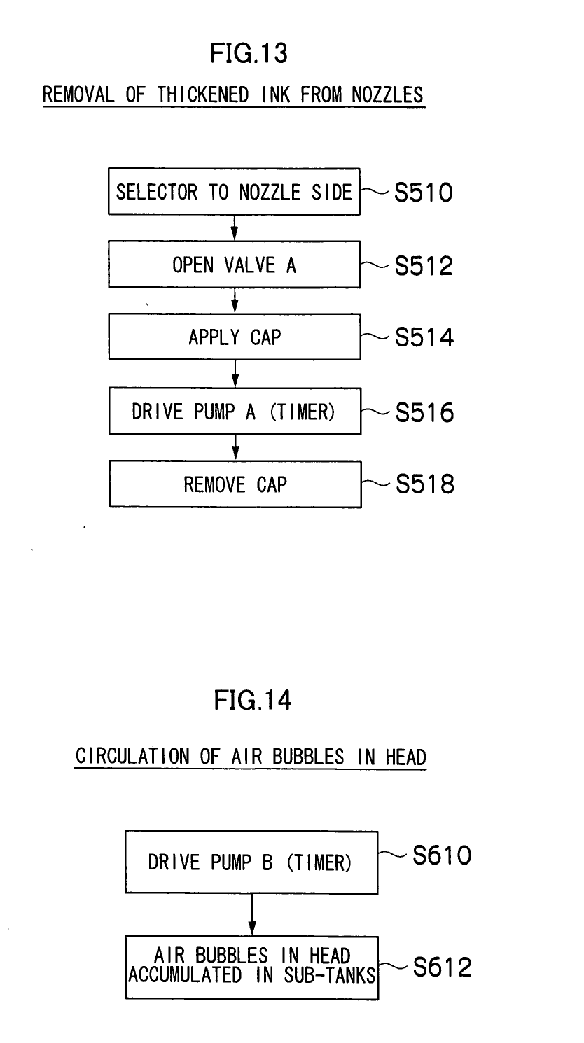

FIG. 14 is a flow chart showing the sequence of the process for discharging air bubbles mixed in the print head 50 from the head by circulating the ink. This process is performed during nonprinting (for example, during print standby).

Specifically, time is managed by the timer 174 during nonprinting, and the pump 132 for forced circulation is actuated if the print standby mode has continued for a specific period of time (step S610). The operation of the pump 132 is also managed by the timer 174, and the pump is automatically stopped after a specific amount of time has elapsed. Ink is circulated in the print head 50 by the operation of the pump 132, and the air bubbles in the head are accumulated in the sub-tanks 110 (step S612).

Thus, it is possible to effectively remove air bubbles according to the frequency of usage by individually controlling the independent circulation channels of the print head 50.

Another embodiment of the present invention will now be described.

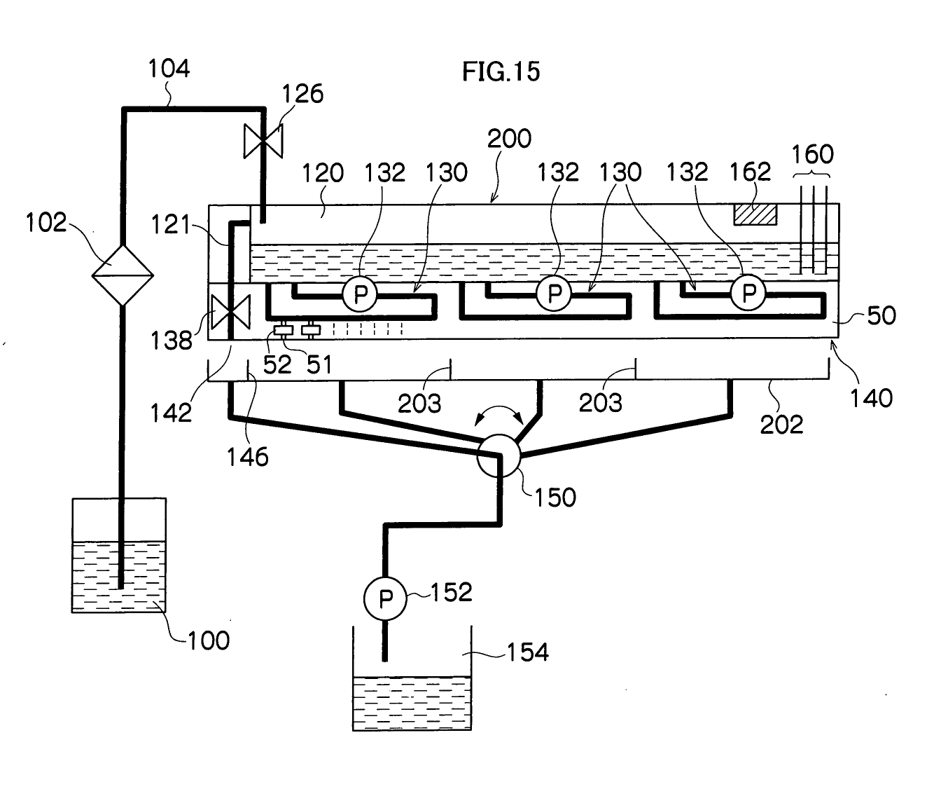

FIG. 15 is a structural drawing showing another embodiment of the present invention. The members in FIG. 15 that are identical or similar to those in FIGS. 7 and 8 are denoted by the same symbols, and descriptions thereof are omitted.

In the embodiment shown in FIG. 15, one sub-tank 200 is disposed on top of the print head 50, and a plurality of ink flow channels 130 are connected to the sub-tank 200. Such a configuration has merits in that the structure is simpler compared to the configuration shown in FIG. 7.

Also, the suction cap 202 shown in FIG. 15 has a size that corresponds with the nozzle surface 140 of the print head 50 (a size substantially equivalent to the nozzle surface 140), and the interior is divided into a plurality of areas by a partitioning wall 203. The cap areas divided by the partitioning wall 203 are communicated with the pump 152 via the selector 150, and suctioning can be selectively performed by switching the connection destination of the pump 152 by means of the selector 150. Therefore, the suction cap 202 does not need to move in a direction that is level with the nozzle surface 140. The operation of the configuration shown in FIG. 15 is identical to the example described in FIG. 7. Another possibility is an embodiment wherein the ink suctioned and recovered from the suction cap 202 is returned to the ink bottle 100 and reused.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An inkjet recording head assembly, comprising:
a recording head which has nozzles discharging ink;
a main tank which is a supply source of the ink; and
an auxiliary tank which communicates with the main tank, the auxiliary tank being in direct connection to the recording head without interposing tubes, a circulation channel being formed by the auxiliary tank and an ink flow channel in the recording head, the auxiliary tank having an exhaust channel connected to a pressure reduction device which reduces inner pressure of the auxiliary tank.

2. The inkjet recording head assembly as defined in claim 1, wherein the recording head has a plurality of independent ink flow channels formed in the recording head, and the plurality of independent ink flow channels are connected to the auxiliary tank to form a plurality of circulation channels.

3. The inkjet recording head assembly as defined in claim 2, wherein the recording head is a full-line recording head with the plurality of nozzles discharging the ink arrayed over a length corresponding to an entire width of a printing medium.

4. The inkjet recording head assembly as defined in claim 1, wherein a suction port for the exhaust channel communicated with the auxiliary tank is provided to the same surface as the nozzles of the recording head.

5. The inkjet recording head assembly as defined in claim 1, further comprising a pump which forces circulation of the ink in the ink flow channel, the pump being arranged in the ink flow channels.

6. The inkjet recording head assembly as defined in claim 5, wherein the circulation channel comprises a supply channel for supplying the ink from the auxiliary tank to the nozzles during printing, and a liquid feed channel used during forced circulation caused by the pump.

7. An inkjet recording apparatus, comprising:
the inkjet recording head assembly as defined in claim 1; and
a pump used for the pressure reduction device,
wherein the pump is also used as a nozzle suction pump which removes the ink in the nozzles by suction.

8. The inkjet recording apparatus as defined in claim 7, further comprising a connection-switching device which selectively switches connection destination of the pressure reduction device used as the nozzle suction pump over to the auxiliary tank and the nozzles.

9. The inkjet recording apparatus as defined in claim 8, further comprising a suction cap adapted to closely fit a nozzle surface of the recording head, the suction cap having a segmented structure divided into an exhaust side support and a nozzle side support by an inner partitioning wall, the suction cap having a configuration in which one of the exhaust side support and the nozzle side support is selectively connected to the pressure reduction device through the connection-switching device.
